(19) United States
(12) Patent Application Publication
(10) Pub. No.: US 2026/0038710 A1
(43) Pub. Date: Feb. 5, 2026

(54) FLEXIBLE FLAT CABLE

(71) Applicant: SUMITOMO ELECTRIC INDUSTRIES, LTD., Osaka-shi (JP)

(72) Inventors: Hiroyasu SUGIYAMA, Kanuma-shi (JP); Kouya MATSUSHITA, Kanuma-shi (JP)

(73) Assignee: SUMITOMO ELECTRIC INDUSTRIES, LTD., Osaka-shi (JP)

(21) Appl. No.: 19/277,551

(22) Filed: Jul. 23, 2025

(30) Foreign Application Priority Data
Aug. 1, 2024 (JP) 2024-126220

(51) Int. Cl. H01B 7/08

(52) U.S. Cl. CPC H01B 7/08

(57) ABSTRACT

A flexible flat cable according to an embodiment includes at least one bent portion including a first portion and a second portion provided to face the first portion, and a contact portion configured to bring the first portion and the second portion into close contact with each other.

### CROSS REFERENCE TO RELATED APPLICATIONS

This application claims priority based on Japanese Patent Application No. 2024-126220filed on Aug. 1, 2024, the entire contents of which are incorporated herein by reference.

### TECHNICAL FIELD

The present disclosure relates to a flexible flat cable.

### BACKGROUND

Patent Literature (Japanese Unexamined Patent Application Publication No. 2004-221044) describes a flat cable. The flat cable is formed in a belt-like shape and flexibly as a whole. The flat cable includes a conductor portion and insulating portions sandwiching the conductor portion. The flat cable has a folded portion that is folded back at a specific part. A connection terminal is connected to the folded portion. The connection terminal includes a body portion, a connection base portion extending from the body portion, and a plurality of connection protrusions protruding from the connection base portion. The connection protrusions penetrate the folded portion, thereby the connection terminal is attached to the flat cable.

### SUMMARY

A flexible flat cable according to an embodiment includes at least one bent portion including a first portion and a second portion provided to face the first portion, and a contact portion configured to bring the first portion and the second portion into close contact with each other.

### BRIEF DESCRIPTION OF THE DRAWINGS

FIG. 1 is a perspective view of a flexible flat cable according to an embodiment.

FIG. 2 is a schematic side view of a flexible flat cable.

FIG. 3 is a schematic view of a bent portion and a contact portion of a flexible flat cable according to an embodiment.

FIG. 4 is a schematic view of a flexible flat cable according to an embodiment in an unfolded state.

FIG. 5 is a schematic view of the flexible flat cable illustrated in FIG. 4 in a folded state.

FIG. 6 is a schematic view of a flexible flat cable according to a first modification.

FIG. 7 is a schematic view of a flexible flat cable according to a second modification.

FIG. 8 is a schematic view of a flexible flat cable according to a third modification.

FIG. 9 is a diagram illustrating a flexible flat cable according to an Example.

### DETAILED DESCRIPTION

A flexible flat cable may be folded to reduce an area occupied by the flexible flat cable. However, a repulsive force that works to open the bent portion can be generated in the folded flexible flat cable. Thus, in the flexible flat cable, it is required to reduce the area occupied by the flexible flat cable and to reduce the repulsive force when the flexible flat cable is folded

An object of the present disclosure is to provide a flexible flat cable that can reduce an occupied area and reduce a repulsive force.

According to the present disclosure, the occupied area can be reduced and the repulsive force can be reduced.

First, the contents of embodiments of the present disclosure will be listed and described.
(1) A flexible flat cable according to an embodiment includes at least one bent portion including a first portion and a second portion provided to face the first portion, and a contact portion configured to bring the first portion and the second portion into close contact with each other.

In the above configuration, the first portion and the second portion in the at least one bent portion are brought into close contact with each other by the contact portion. By the bent portion being provided, an area occupied by the flexible flat cable can be reduced. The contact portion allows the first portion and the second portion to be in close contact with each other, thereby reducing a repulsive force that works to open the bent portion.
(2) In the flexible flat cable according to the above (1), the contact portion may be located inside the at least one bent portion. In this case, the contact portion can be easily disposed inside the bent portion.
(3) In the flexible flat cable according to the above (1), the contact portion may be located outside the at least one bent portion.
(4) In the flexible flat cable according to any one of the above (1) to (3), the at least one bent portion may include a first bent portion and a second bent portion adjacent to the first bent portion. The first portion and the second portion of the first bent portion may be provided at a surface of the flexible flat cable opposite to a surface at which the first portion and the second portion of the second bent portion are provided. In this case, the first portion and the second portion of the first bent portion are provided at the surface opposite to the surface at which the first portion and the second portion of the second bent portion are provided, and thus it is possible to further reduce the area occupied by the flexible flat cable.
(5) In the flexible flat cable according to any one of the above (1) to (3), the at least one bent portion may include a first bent portion and a second bent portion adjacent to the first bent portion. The first portion and the second portion of the first bent portion may be provided at the same surface of the flexible flat cable as the first portion and the second portion of the second bent portion. In this case, the first portion and the second portion of the first bent portion are provided at the same surface as the first portion and the second portion of the second bent portion, and thus it is possible to enhance the flexibility in arrangement of the flexible flat cable.
(6) In the flexible flat cable according to any one of the above (1) to (5), the at least one bent portion may include a first bent portion and a second bent portion adjacent to the first bent portion. A distance between the first bent portion and the second bent portion may be 40 mm or less. In this case, the area occupied by the flexible flat cable can be further reduced.
(7) In the flexible flat cable according to any one of the above (1) to (6), the contact portion may be a double-sided tape that is provided to adhere the first portion and the second portion to each other. In this case, the contact portion can be easily disposed in the bent portion.
(8) In the above (3), the contact portion may be a tape that is wrapped around an outside of the at least one bent portion so that the first portion is in close contact with the second portion. Details of Embodiments of Present Disclosure

Specific examples of embodiments of the present disclosure will be described below with reference to the drawings. The present invention is not limited to these examples, but is defined by the scope of the claims, and is intended to include all modifications within the meaning and scope equivalent to the scope of the claims. In the description of the drawings, the same or corresponding elements are denoted by the same reference numerals, and redundant description thereof will be omitted where appropriate.

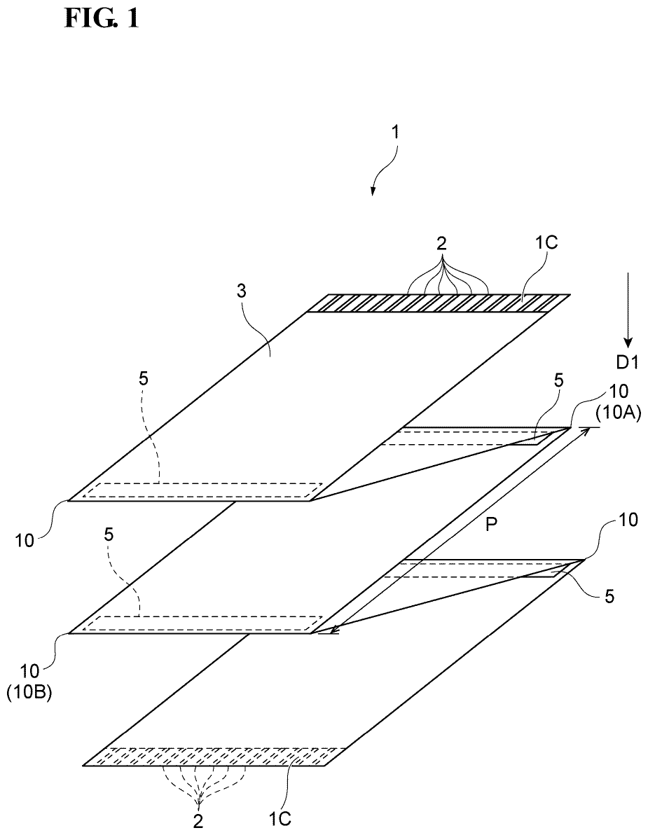

FIG. 1 is a perspective view of a flexible flat cable 1 according to an embodiment. As shown in FIG. 1, the flexible flat cable 1 is formed in a tape shape. The flexible flat cable 1 has a plurality of bent portions 10 arranged along a direction D1 in which the flexible flat cable 1 extends. For example, a thickness direction of the flexible flat cable 1 coincides with the direction D1. The flexible flat cable 1 is foldable by the plurality of bent portions 10, for example. When the flexible flat cable 1 is folded, the plurality of bent portions 10 are stacked along the direction D1. The flexible flat cable 1 electrically connects a pair of circuits (not shown) arranged along the direction D1, for example.

For example, the plurality of bent portions 10 are arranged at equal distances on the flexible flat cable 1. Each of the bent portions 10 includes a first bent portion 10A and a second bent portion 10B adjacent to the first bent portion 10A. A distance P between the first bent portion 10A and the second bent portion 10B is, for example, 40 mm or less. The distance P may be a distance between two bent portions 10 adjacent to each other on the flexible flat cable 1. The distance P may be more than 0 mm and 30 mm or less, or more than 0 mm and 20 mm or less. The value of the distance P can be changed as appropriate.

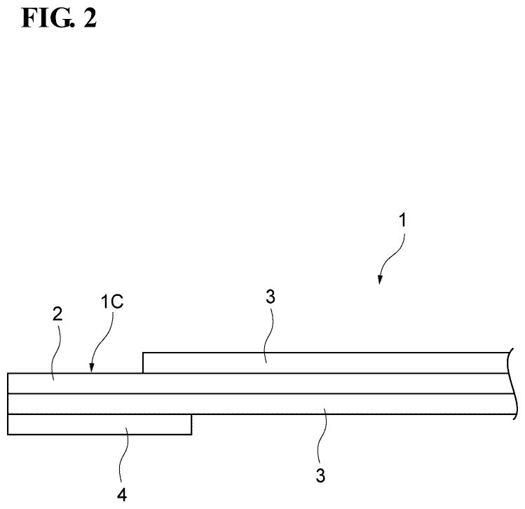

FIG. 2 is a schematic view of an end portion 1C of the flexible flat cable 1. As shown in FIG. 1 and FIG. 2, the flexible flat cable 1 includes a plurality of conductors 2 arranged side by side, a pair of insulation layers 3 sandwiching the conductors 2, and a supporting tape 4. The conductors 2 are exposed at the end portion 1C of the flexible flat cable 1. The conductors 2 are, for example, flat conductors. However, the conductors 2 may be round conductors, and the shapes of the conductors 2 are not particularly limited. The conductors 2 are, for example, annealed copper wires. In this case, at the end portion 1C, the conductors 2 may be plated with nickel and gold in this order. The conductors 2 may be nickel-plated annealed copper wires. In this case, the conductors 2 may be plated with gold at the end portion 1C. The conductors 2 may be formed of a tin-plated conductor. As described above, the material of the conductors 2 is not particularly limited.

The conductors 2 exposed at the end portion 1C in the direction D1 of the flexible flat cable 1 and the conductors 2 exposed at the end portion 1C in a direction opposite to the direction D1 of the flexible flat cable 1 are connected to respective circuits, and thus the pair of circuits are electrically connected to each other. For example, as shown in FIG. 1, the conductors 2 are exposed in the direction D1 at one end portion 1C of the flexible flat cable 1, while the other conductors 2 are exposed in a direction opposite to the direction D1 at the other end portion 1C of the flexible flat cable 1. However, the directions in which the conductors 2 are exposed are not limited to the above example.

The flexible flat cable 1 is in a state of extending in a tape shape when the bent portion 10 is not formed. Hereinafter, a direction in which the flexible flat cable 1 extends may be referred to as a longitudinal direction of the flexible flat cable 1, and a lateral direction of the flexible flat cable 1 orthogonal to the longitudinal direction may be referred to as a width direction of the flexible flat cable 1. The flexible flat cable 1 has the plurality of conductors 2. The plurality of conductors 2 are arranged along the width direction of the flexible flat cable 1.

For example, the flexible flat cable 1 includes six conductors 2. However, the number of conductors 2 is not particularly limited. The flexible flat cable 1 includes a pair of insulation layers 3 arranged along the thickness direction of the flexible flat cable 1. For example, the insulation layers 3 may each have a two-layer structure formed of an insulating base material and an adhesive layer. The conductors 2 are sandwiched between the pair of insulation layers 3 in a portion of the flexible flat cable 1 other than the end portion 1C. The supporting tape 4 is fixed to one of the insulation layers 3 at the end portion 1C. At the end portion 1C, the conductors 2, the insulation layer 3, and the supporting tape 4 are arranged in this order along the thickness direction of the flexible flat cable 1.

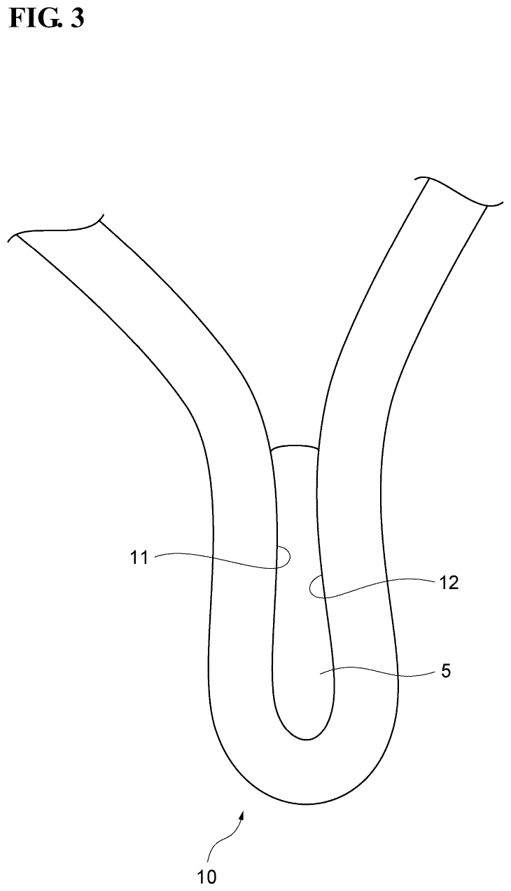

FIG. 3 is an enlarged view of the bent portion 10. As shown in FIG. 1 and FIG. 3, the bent portion 10 is formed of a first portion 11 and a second portion 12 of the flexible flat cable 1 that extend in different directions from each other. The bent portion 10 includes the first portion 11 and the second portion 12 provided to face the first portion 11. The first portion 11 and the second portion 12 are provided at the same surface of the flexible flat cable 1. The flexible flat cable 1 includes a contact portion 5 which is in close contact with both the first portion 11 and the second portion 12 between the first portion 11 and the second portion 12.

The contact portion 5 is a component that exerts a force to bring the first portion 11 and the second portion 12 into close contact with each other. The contact portion 5 is located inside the bent portion 10. The inside of the bent portion 10 means a portion between the first portion 11 and the second portion 12. The contact portion 5 extends along the width direction of the flexible flat cable 1. For example, the contact portion 5 is formed in a rectangular shape having long sides extending in the width direction of the flexible flat cable 1 and short sides extending in the longitudinal direction of the flexible flat cable 1. In this case, the short sides of the contact portion 5 have a length (width) of 2.5 mm to 5.0 mm, for example. However, the shape and length of the contact portion 5 are not particularly limited. The contact portion 5 is, for example, a double-sided tape provided to adhere the first portion 11 and the second portion 12 to each other. However, the contact portion 5 may be, for example, an adhesive, and the type of the contact portion 5 is not particularly limited. When the contact portion 5 is formed by laser welding or ultrasonic welding, the contact portion 5 is formed of the insulation layers 3.

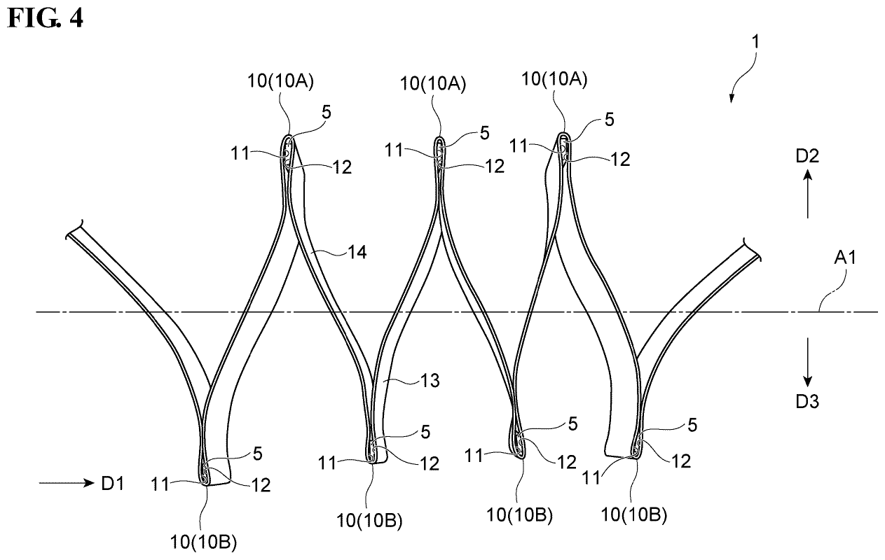

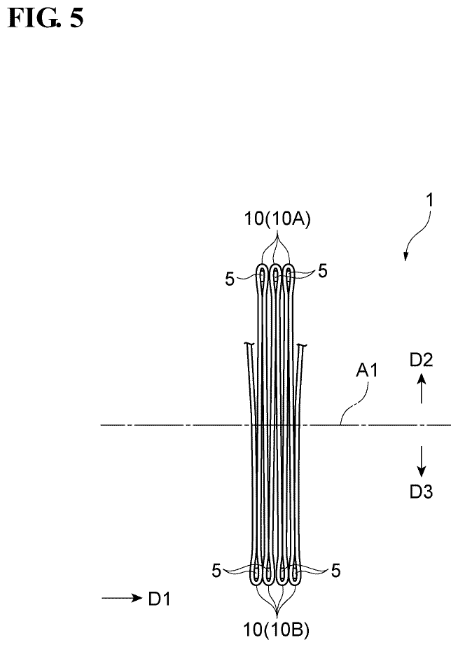

FIG. 4 illustrates the flexible flat cable 1 which is pulled along the direction D1. FIG. 5 illustrates the flexible flat cable 1 which is not pulled. A direction away from a reference line A1 is referred to as a first direction D2, and a direction opposite to the first direction D2 is referred to as a second direction D3. As shown in FIG. 4 and FIG. 5, the plurality of bent portions 10 each include the first bent portion 10A that protrudes toward the first direction D2 and the second bent portion 10B that is adjacent to the first bent portion 10A in the direction D1 in which the flexible flat cable 1 extends and protrudes toward the second direction D3. The reference line A1 is a hypothetical straight line extending along the direction D1 between one bent portion 10 and another bent portion 10 adjacent to the one bent portion 10 on the flexible flat cable 1.

The first portion 11 and the second portion 12 of the first bent portion 10A are provided at a surface of the flexible flat cable 1 opposite to a surface at which the first portion 11 and the second portion 12 of the second bent portion 10B are provided. The flexible flat cable 1 has a first surface 13 and a second surface 14 opposite to the first surface 13. The first portion 11 and the second portion 12 of the first bent portion 10A are provided at the first surface 13 of the flexible flat cable 1, and the first portion 11 and the second portion 12 of the second bent portion 10B are provided at the second surface 14 of the flexible flat cable 1. In the pair of insulation layers 3, the insulation layer 3 having the first surface 13 is referred to as a first insulation layer, and the insulation layer 3 having the second surface 14 is referred to as a second insulation layer. This means that the first portion 11 and the second portion 12 of the first bent portion 10A are provided at the first insulation layer, and the first portion 11 and the second portion 12 of the second bent portion 10B are provided at the second insulation layer.

The flexible flat cable 1 includes the plurality of first bent portions 10A and the plurality of second bent portions 10B. The plurality of first bent portions 10A are arranged along the direction D1. The plurality of second bent portions 10B are arranged along the direction D1. For example, the first bent portion 10A and the second bent portion 10B are alternately arranged in the extending direction D1 of the flexible flat cable 1.

In the flexible flat cable 1, the first portion 11 and the second portion 12 in the bent portion 10 are in close contact with each other by the contact portion 5. The bent portion 10 allows the area occupied by the flexible flat cable 1 to be reduced as a whole. The contact portion 5 allows the first portion 11 and the second portion 12 to be in close contact with each other, thereby reducing a repulsive force that works to open the bent portion 10. In cable routing, the work of connecting the flexible flat cable 1 or the like can be easily performed. When the flexible flat cable is stored, the flexible flat cable can be folded without any disorder, and an occupied volume as a whole can be reduced.

The contact portion 5 may be disposed inside the bent portion 10. In this case, the contact portion 5 can be easily disposed inside the bent portion 10. In addition, the bent portion 10 may include the first bent portion 10A and the second bent portion 10B adjacent to the first bent portion 10A. The first portion 11 and the second portion 12 of the first bent portion 10A may be provided at a surface of the flexible flat cable 1 opposite to a surface at which the first portion 11 and the second portion 12 of the second bent portion 10B are provided. In this case, the first portion 11 and the second portion 12 of the first bent portion 10A are provided at the surface opposite to the surface at which the first portion 11 and the second portion 12 of the second bent portion 10B are provided, and thus the area occupied by the flexible flat cable 1 can be further reduced.

The distance P between the first bent portion 10A and the second bent portion 10B may be 40 mm or less. In this case, the area occupied by the flexible flat cable 1 can be further reduced. In addition, the contact portion 5 may be a double-sided tape provided to adhere the first portion 11 and the second portion 12 to each other. In this case, the contact portion 5 can be easily disposed in the bent portion 10 by attaching the double-sided tape.

Next, various modifications of the flexible flat cable according to the present disclosure will be described. Some of the configuration of the flexible flat cable according to each modification described below is the same as some of the configuration of the flexible flat cable 1 described above. Therefore, in the following description, the same contents as those of the above-described configuration are denoted by the same reference numerals, and the description thereof will be omitted where appropriate.

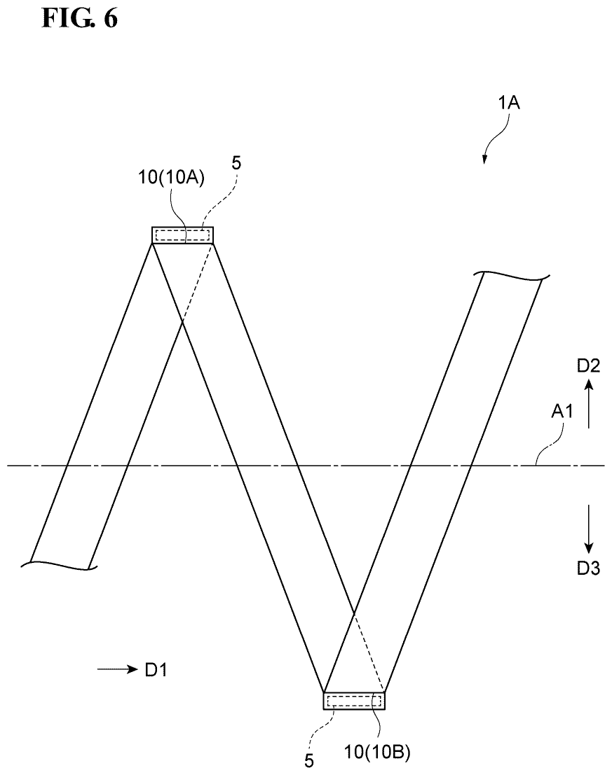

FIG. 6 is a diagram illustrating a flexible flat cable 1A according to a first modification. The flexible flat cable 1A is used in an unfolded state. The flexible flat cable 1A extends obliquely relative to the direction D1. In the flexible flat cable 1A, the first bent portion 10A and the second bent portion 10B are alternately provided, and a direction in which the flexible flat cable 1A extends changes at each of the first bent portion 10A and the second bent portion 10B. The flexible flat cable 1A enhances the flexibility in arrangement and allows for easy arrangement.

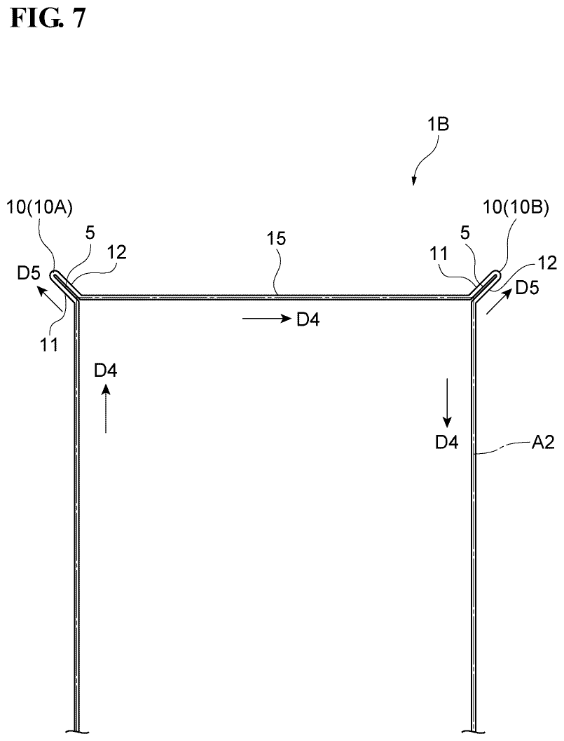

FIG. 7 is a diagram illustrating a flexible flat cable 1B according to a second modification. The flexible flat cable 1B is used in an unfolded state. As shown in FIG. 7, a direction D4 in which the flexible flat cable 1B extends changes at the bent portion 10. When a line extending along the direction D4 in the flexible flat cable 1B is defined as a reference line A2, the bent portion 10 protrudes from a reference line A2 toward a direction D5. The angle between the direction D5 and the direction D4 is, for example, 135°.

The plurality of bent portions 10 includes the first bent portion 10A and the second bent portion 10B adjacent to the first bent portion 10A. In FIG. 7, the first portion 11 and the second portion 12 of the first bent portion 10A are provided at the same first surface 15 of the flexible flat cable 1B as the first portion 11 and the second portion 12 of the second bent portion 10B. By these being provided at the same first surface 15, when the flexible flat cable 1B is disposed in an arrangement form having a corner, the flexibility in arrangement of the flexible flat cable 1B is enhanced and can be easily disposed. In FIG. 7, the first bent portion 10A and the second bent portion 10B are disposed on an outer side of the flexible flat cable 1B, but one or both of the first bent portion 10A and the second bent portion 10B may be disposed on an inner side of the flexible flat cable 1B based on the arrangement form of the flexible flat cable 1B. When one of the first bent portion 10A and the second bent portion 10B is disposed on the inner side, the first portion 11 and the second portion 12 of the first bent portion 10A are provided at a surface of the flexible flat cable 1B opposite to a surface at which the first portion 11 and the second portion 12 of the second bent portion 10B are provided. That is, one of the first bent portion 10A and the second bent portion 10B is provided at the first surface, and the other is provided at the second surface opposite to the first surface. FIG. 7 illustrates two bent portions 10, but the flexible flat cable 1B may have three or more bent portions 10. In this case, one of adjacent bent portions 10 may be disposed on the outer side and the other may be disposed on the inner side, based on the arrangement form of the flexible flat cable 1B. The adjacent bent portions 10 may be disposed either together on the outer side or together on the inner side.

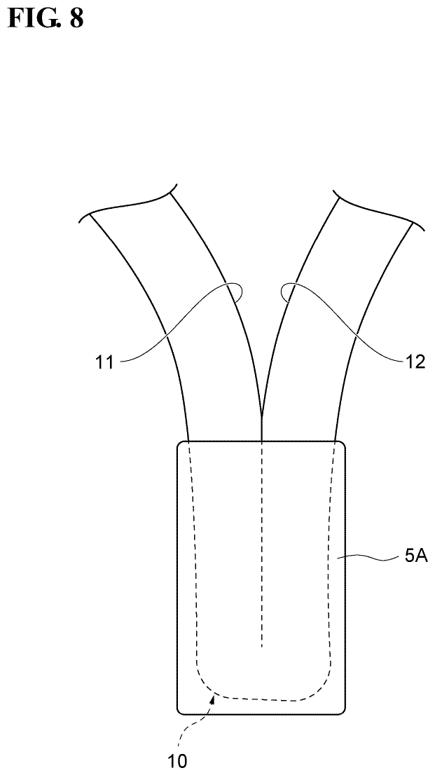

FIG. 8 is a view illustrating a contact portion 5A of a flexible flat cable according to a third modification. The contact portion 5A is located outside the bent portion 10. The contact portion 5A presses the first portion 11 and the second portion 12 from the outside of the bent portion 10 to bring the first portion 11 and the second portion 12 into close contact with each other. For example, the contact portion 5A is a tape that is wrapped around the first portion 11 and the second portion 12 so that the first portion 11 is in close contact with the second portion 12. However, the contact portion 5A may be a clip that pinches the first portion 11 and the second portion 12, and the type, material, and structure of the contact portion 5A are not particularly limited. As described above, even in the flexible flat cable including the contact portion 5A located outside the bent portion 10, the first portion 11 and the second portion 12 are prevented from being opened, and thus the same effects as in the above-described flexible flat cable 1 can be achieved.

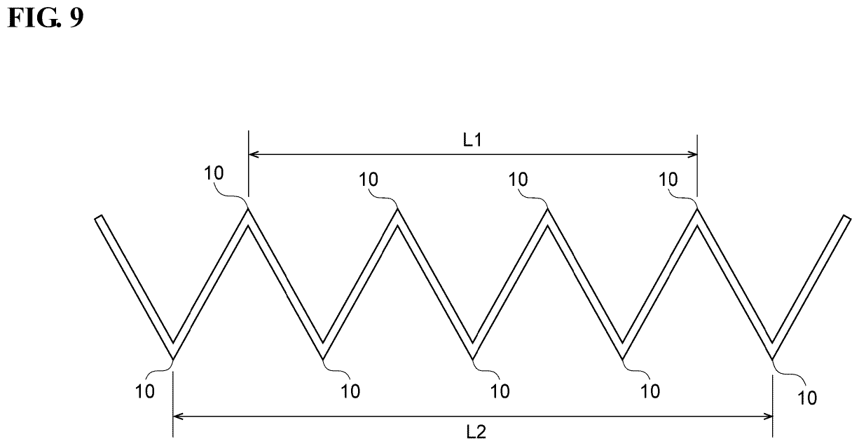

Next, examples of the flexible flat cable according to the present disclosure will be described. In the examples, as illustrated in FIG. 9, a flexible flat cable in which the bent portions 10 were formed at nine positions with a distance of 30 mm was pulled, and after the flexible flat cable was held in the pulled state for several seconds, lengths L1 and L2 after releasing the pulling were measured. Then, the both ends of the flexible flat cable 1 were brought close to each other from a natural state in which no force was applied, and it was evaluated whether the flexible flat cable 1 was able to maintain the folded state without being opened by a repulsive force. These measurements were subjected to each of the flexible flat cables according to Example 1 to Example 5 and the flexible flat cables according to Comparative Example 1 to Comparative Example 5.

### EXAMPLE

### Example 1

The flexible flat cable according to Example 1 is the flexible flat cable 1 having the contact portion 5 in the bent portion 10. The conductors 2 each have a thickness of 0.035 mm and a width of 0.3 mm. The number of the conductors 2 is six, and the conductors 2 are annealed copper wires. The contact portion 5 is a double-sided tape having a length of 5 mm in the longitudinal direction.

### Example 2

In the flexible flat cable according to Example 2, the number of conductors 2 is 15. The configuration is the same as in Example 1 except that the number of conductors 2 is 15.

### Example 3

In the flexible flat cable according to Example 3, the contact portion 5 is a double-sided tape having a length of 2.5 mm in the longitudinal direction. The configuration is the same as in Example 2 except that the double-sided tape having the length of 2.5 mm is used.

### Example 4

The flexible flat cable according to Example 4 is the flexible flat cable 1 having the contact portion 5 in the bent portion 10. The conductors 2 each have a thickness of 0.05 mm and a width of 0.7 mm. The number of the conductors 2 is 12, and the conductors 2 are nickel-plated annealed copper wires. The contact portion 5 is a double-sided tape having a length of 2.5 mm in the longitudinal direction.

### Example 5

The flexible flat cable according to Example 5 is a flexible flat cable having the contact portion 5A outside the bent portion 10. The contact portion 5A is a tape that is wrapped around the outside of the bent portion and has a length of 2.5 mm in the longitudinal direction. The configuration is the same as in Example 4 except that this contact portion 5A is used.

### COMPARATIVE EXAMPLE

### Comparative Example 1

The flexible flat cable according to Comparative Example 1 includes neither the contact portion 5 nor the contact portion 5A described above. Comparative Example 1 is the same as Example 1 except that neither the contact portion 5 nor the contact portion 5A is provided.

### Comparative Example 2

The flexible flat cable according to Comparative Example 2 includes neither the contact portion 5 nor the contact portion 5A described above. Comparative Example 2 is the same as Example 2 except that neither the contact portion 5 nor the contact portion 5A is provided.

### Comparative Example 3

The flexible flat cable according to Comparative Example 3 includes neither the contact portion 5 nor the contact portion 5A described above. Comparative Example 3 is the same as Example 3 except that neither the contact portion 5 nor the contact portion 5A is provided.

### Comparative Example 4

The flexible flat cable according to Comparative Example 4 includes neither the contact portion 5 nor the contact portion 5A described above. Comparative Example 4 is the same as Example 4 except that neither the contact portion 5 nor the contact portion 5A is provided.

### Comparative Example 5

The flexible flat cable according to Comparative Example 5 includes neither the contact portion 5 nor the contact portion 5A described above. Comparative Example 5 is the same as Example 5 except that neither the contact portion 5 nor the contact portion 5A is provided.

The results of the measurements for Example 1 to Example 5 are shown in Table 1 below, and the results of the measurements for Comparative Example 1 to Comparative Example 5 are shown in Table 2 below. The “Distance of cable after pulling” in Table 1 and Table 2 indicates a value of the shorter one of the length L1 and the length L2 after the flexible flat cable is completely folded, then the flexible flat cable is opened to a maximum extent by pulling, and tensile stress is released. The “Disorder in folding” is defined as “No” when the flexible flat cable can be held in a folded state without any disorder in folding the flexible flat cable, and is defined as “Yes” when the flexible flat cable cannot be held in a folded state due to disorder caused by repulsion.

TABLE 1

| | Example 1 | Example 2 | Example 3 | Example 4 | Example 5 |
|---|---|---|---|---|---|
| Distance | 30 mm | 30 mm | 30 mm | 15 mm | 15 mm |
| of cable | | | | | |
| after pulling | | | | | |
| Disorder in | No | No | No | No | No |
| folding | | | | | |

TABLE 2

| | Comparative | Comparative | Comparative: | Comparative | Comparative |
|---|---|---|---|---|---|
| | Example 1 | Example 2 | Example 3 | Example 4 | Example 5 |
| Distance | 130 mm | 130 mm | 130 mm | 120 mm | 120 mm |
| of cable | | | | | |
| after | | | | | |
| pulling | | | | | |
| Disorder in | Yes | Yes | Yes | Yes | Yes |
| folding | | | | | |

As shown in Table 2, for the flexible flat cables according to Comparative Example 1 to Comparative Example 5 which include neither the contact portion 5 nor the contact portion 5A, it has been found that the distance of cable after pulling is 120 mm or more, disorder in folding occurs, and the flexible flat cable cannot be completely folded. As shown in Table 1, for the flexible flat cables according to Example 1 to Example 5 which include the contact portion 5 or the contact portion 5A, it has been found that the distance of cable after pulling is 30 mm or less, and the flexible flat cable can be completely folded without causing disorder in folding.

The embodiments, modifications, and examples of the flexible flat cable according to the present disclosure have been described above. However, the present disclosure is not limited to the above-described embodiments, modifications, or examples. That is, it is easily recognized by those skilled in the art that various modifications and changes can be made to the present invention within the scope of the gist described in the claims. For example, the shape, size, number, material, and arrangement of each part of the flexible flat cable can be changed as appropriate within the scope of the above gist.

What is claimed is:

1. A flexible flat cable comprising:
at least one bent portion including a first portion and a second portion provided to face the first portion; and
a contact portion configured to bring the first portion and the second portion into close contact with each other.

2. The flexible flat cable according to claim 1,
wherein the contact portion is located inside the at least one bent portion.

3. The flexible flat cable according to claim 1,
wherein the contact portion is located outside the at least one bent portion.

4. The flexible flat cable according to claim 1,
wherein the at least one bent portion includes a first bent portion and a second bent portion adjacent to the first bent portion, and
wherein the first portion and the second portion of the first bent portion are provided at a surface of the flexible flat cable opposite to a surface at which the first portion and the second portion of the second bent portion are provided.

5. The flexible flat cable according to claim 1,
wherein the at least one bent portion includes a first bent portion and a second bent portion adjacent to the first bent portion, and
wherein the first portion and the second portion of the first bent portion are provided at a same surface of the flexible flat cable as the first portion and the second portion of the second bent portion.

6. The flexible flat cable according to claim 1,
wherein the at least one bent portion includes a first bent portion and a second bent portion adjacent to the first bent portion, and
wherein a distance between the first bent portion and the second bent portion is 40 mm or less.

7. The flexible flat cable according to claim 1,
wherein the contact portion is a double-sided tape that is provided to adhere the first portion and the second portion to each other.

8. The flexible flat cable according to claim 3,
wherein the contact portion is a tape that is wrapped around an outside of the at least one bent portion so that the first portion is in close contact with the second portion.
